(19) United States
(12) Patent Application Publication
(10) Pub. No.: US 2017/0325293 A1
(43) Pub. Date: Nov. 9, 2017

(54) Appliance Heating Element with Integrated Temperature Sensing

(71) Applicant: General Electric Company, Schenectady, NY (US)

(72) Inventors: James Carter Bach, Seymour, IN (US); Eugenio Gomez, Louisville, KY (US)

(21) Appl. No.: 15/147,934

(22) Filed: May 6, 2016

(51) Int. Cl. H05B 3/76; H05B 3/24; H05B 1/02

(52) U.S. Cl. CPC H05B 3/76; H05B 1/0266; H05B 3/24

(57) ABSTRACT

Heating assemblies for cooktop appliances are provided. In one embodiment, the heating assemblies include a first portion and a second portion. The first portion includes a heat generating component and a first sheath surrounding the heat generating component. The first sheath defines a first support surface. The second portion includes a temperature sensing component and a second sheath surrounding the temperature sensing component. The second sheath defines a second support surface. The first support surface and the second support surface contact a cooking utensil when the cooking utensil is positioned on the heating assembly. The heat generating component may be configured to provide heat to the cooking utensil positioned on the heating assembly, and the temperature sensing component may be configured to sense the temperature of the cooking utensil in order to assist in regulating the temperature of the cooking utensil.

### FIELD OF THE INVENTION

The present subject matter relates generally to cooking appliances and heating assemblies for cooking appliances. More particularly, the present subject matter relates to heating assemblies for cooking appliances that generate heat as well as sense a temperature of a cooking utensil positioned on the heating assembly.

### BACKGROUND OF THE INVENTION

Cooking appliances, such as, e.g., cooktops or ranges (also known as hobs or stoves), generally include one or more heated portions for heating or cooking food items within a cooking utensil placed on the heated portion. The heated portions utilize one or more heating sources to output heat, which is transferred to the cooking utensil and thereby to any food item or items within the cooking utensil. Typically, a controller or other control mechanism, such as an electromechanical switch, regulates the heat output of the heating source selected by a user of the cooking appliance, e.g., by turning a knob or interacting with a touch-sensitive control panel. For example, the control mechanism may cycle the heating source between an activated or on state and a substantially deactivated or off state such that the average heat output of the heating source approximates the user-selected heat output level.

The control mechanism can utilize a temperature sensor to help control the heat output in order to regulate or otherwise limit the cooking utensil to a desired temperature level. The transfer of heat to the cooking utensil and/or food items may cause the food items or cooking utensil to overheat or otherwise cause unwanted and/or unsafe conditions on the cooktop. Although the cooking appliance usually has features for regulating the heat output of the heating source as described above, setting the heat output to a high level can cause the cooking utensil, and its contents, to reach excessively high temperatures. As an example, a high heat output setting may cause a frying pan or skillet containing only a thin layer of cooking oil to quickly rise in temperature because the thermal mass of the cooking utensil and cooking oil is small. In some cases, the temperature may rise such that the oil self-ignites. On the other hand, a high heat output setting typically does not lead to dangerous conditions for large food loads, e.g., a pot filled with water, because the large thermal mass slows the rate at which the cooking utensil and food heat up and, in this particular example, because water is a self-temperature-regulating compound and is not a self-igniting chemical compound. A temperature sensor may assist the control mechanism in regulating the heat output so that undesirable conditions can be avoided without negatively impacting cooking performance.

Typical temperature sensors are mounted to the cooking appliance such that the sensors are positioned in proximity to the heated portion to sense the temperature of a cooking utensil. However, the temperature sensors usually are mounted to a chassis or other portion of the cooking appliance such that the sensors cannot be removed, e.g., for cleaning an area around the heated portion, and require the heated portion's geometry be configured to accommodate the sensor, e.g., through openings in the heating element of the heated portion. Moreover, typical temperature sensors configured to contact a bottom surface of the cooking utensil generally require a heat shield or other device to minimize the effects of heat radiating from the heating element, as well as to protect the sensor, e.g., as a user removes a drip tray beneath the heating element for cleaning. Additionally, because conventional temperature sensors and/or their associated hardware extend through a bottom surface beneath the heated portion, such sensors and/or their hardware are prone to contamination from boil-over events.

Accordingly, a heating assembly having a heat generating component and a temperature sensing component would be useful. In particular, a heating assembly having a heat generating component and a temperature sensing component that can be removed as a single unit would be beneficial.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a heating assembly for a cooktop appliance is provided. The heating assembly includes a first portion and a second portion. The first portion has a heat generating component and a first sheath surrounding the heat generating component. The first sheath defines a first support surface. The second portion has a temperature sensing component and a second sheath surrounding the temperature sensing component. The second sheath defines a second support surface. The first support surface and the second support surface contact a cooking utensil when the cooking utensil is positioned on the heating assembly.

In another exemplary embodiment of the present disclosure, a heating assembly for a cooktop appliance is provided. The heating assembly includes a first portion and a second portion. The first portion has a heat generating wire and a first sheath defining a first support surface. The heat generating wire extends within the first sheath such that the first sheath surrounds the heat generating wire. The second portion has a temperature sensitive wire and a second sheath defining a second support surface. The temperature sensitive wire extends within the second sheath such that the second sheath surrounds the temperature sensitive wire. The first support surface and the second support surface contact a cooking utensil when the cooking utensil is positioned on the heating assembly.

In a further exemplary embodiment of the present disclosure, a heating assembly for a cooktop appliance is provided. The heating assembly includes a first portion and a second portion. The first portion has a heat generating wire and a first sheath defining a first support surface. The heat generating wire extends within the first sheath such that the first sheath surrounds the heat generating wire. The second portion has a temperature sensor and a second sheath surrounding the temperature sensor. The second sheath surrounds the temperature sensor and defines a second support surface. The first support surface and the second support surface contact a cooking utensil when the cooking utensil is positioned on the heating assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a side, perspective view of a cooking appliance according to an exemplary embodiment of the present subject matter.

FIG. 2 provides a top, perspective view of a heating assembly of the cooking appliance of FIG. 1 according to an exemplary embodiment of the present subject matter.

FIG. 3 provides a cross-sectional view of a first portion of the heating assembly of FIG. 2.

FIG. 4 provides a cross-sectional view of a second portion of the heating assembly of FIG. 2.

FIG. 5 provides a cross-sectional view of the heating assembly of FIG. 2 with a cooking utensil positioned thereon.

FIG. 6 provides a top, perspective view of the heating assembly according to another exemplary embodiment of the present subject matter.

FIG. 7 provides a top, perspective view of the heating assembly according to another exemplary embodiment of the present subject matter.

FIG. 8 provides a top, perspective view of the heating assembly according to another exemplary embodiment of the present subject matter.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Further, each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

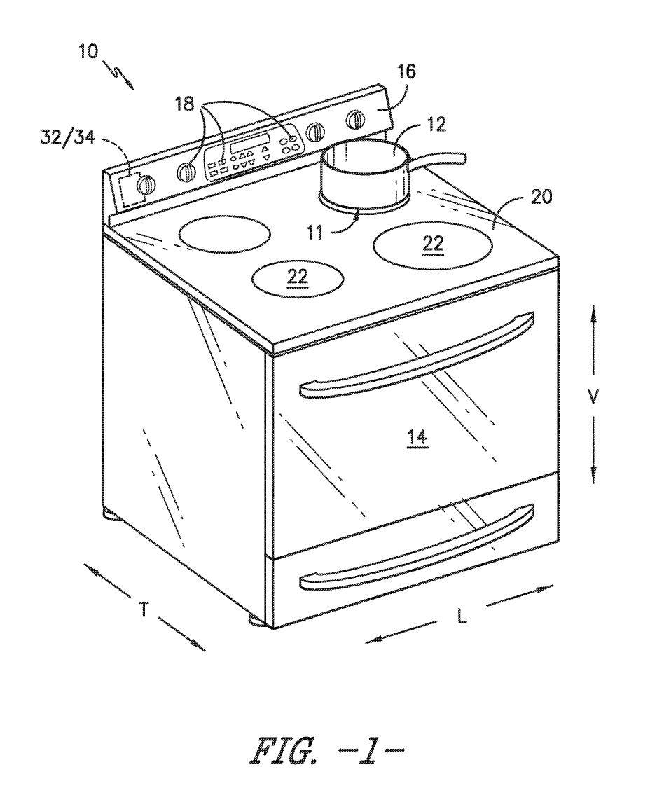

Referring now to the drawings, wherein identical numerals indicate the same elements throughout the figures, FIG. 1 is a side, perspective view of a cooking appliance, generally referred to as a stove or range, according to an exemplary embodiment of the present subject matter. Cooking appliance 10 may be a range appliance as shown in FIG. 1, which has an oven positioned vertically below a cooktop. However, cooking appliance 10 is provided by way of example only and is not intended to limit the present subject matter in any aspect. Thus, the present subject matter may be used with other cooking appliance configurations, e.g., cooktop appliances without an oven. Further, the present subject matter may be used in any other suitable appliance.

Cooking surface 20 of cooking appliance 10 includes heating assemblies 22. Cooking surface 20 may be constructed of a metallic material, e.g., steel or stainless steel. As shown in FIG. 1, a cooking utensil 12, such as a pot, kettle, pan, skillet, or the like, may be placed or positioned on a heating assembly 22 to cook or heat food items placed within the cooking utensil. Further, cooking appliance 10 includes a door 14 that permits access to a cooking chamber (not shown) of an oven portion of appliance 10, the cooking chamber for cooking or baking of food or other items placed therein. A control panel 16 having user controls 18 permits a user to make selections for cooking of food items using heating assemblies 22 and/or the cooking chamber. As an example, a user may manipulate one or more user controls 18 to select, e.g., a power or heat output level for each heating assembly 22. The selected heat output level of heating assembly 22 affects the heat transferred to cooking utensil 12 positioned on heating assembly 22. Although shown on a backsplash or back panel of cooking appliance 10, control panel 16 may be positioned in any suitable location, e.g., along a front edge of the appliance. Controls 18 may include buttons, knobs, and the like, as well as combinations thereof.

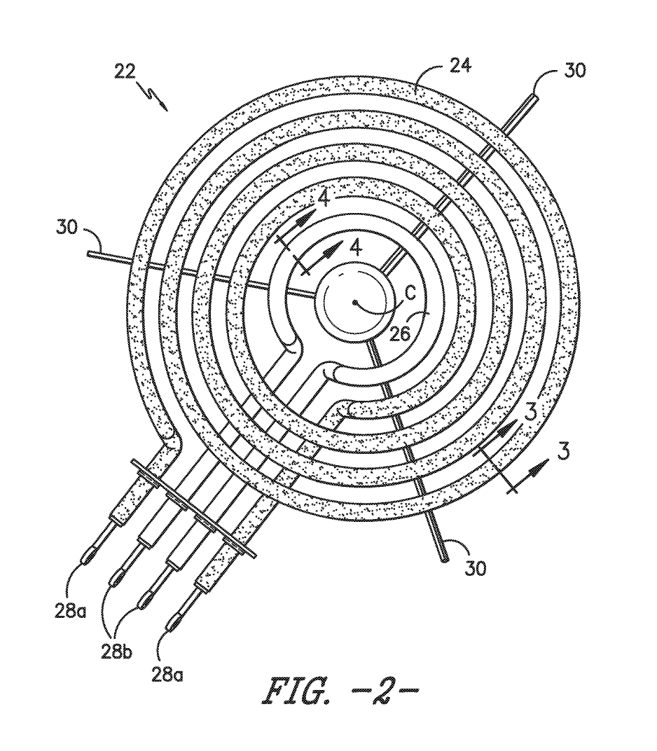

FIG. 2 provides a top view of an exemplary heating assembly 22. In the illustrated exemplary embodiment, heating assembly 22 comprises a first, heat generating portion 24 and a second, temperature sensing portion 26. That is, the first portion 24 and second portion 26 are integrated into one heating assembly 22 such that, e.g., the assembly 22 can be removed from cooking appliance 10 as a single unit. Further, first portion 24 is shaded in FIG. 2 for purposes of clarity only, i.e., to more easily identify first portion 24 and second portion 26 for purposes of discussion herein. It will be appreciated that, at least externally, first portion 24 and second portion 26 need not be visually different from one another, i.e., the external features of first portion 24 and second portion 26 need not appear different to a user of cooking appliance 10.

More particularly, first portion 24 preferably comprises one or more spiral shaped electrical resistive heating elements, although other suitable heating sources may be used as well, for providing heat to a cooking utensil 12 positioned thereon. As such, in the illustrated embodiment, heating assembly 22 utilizes exposed, electrically-heated, helically-wound planar coils as a heat source, i.e., as first portion 24, for heating cooking utensils placed directly on heating assembly 22. Each heating assembly 22 of cooking appliance 10 may be heated by the same type of heating source 24, or cooking appliance 10 may include a combination of different types of heating sources 24. Further, heating assemblies 22 may have any suitable shape and size, and cooking appliance 10 may include a combination of heating assemblies 22 of different shapes and sizes.

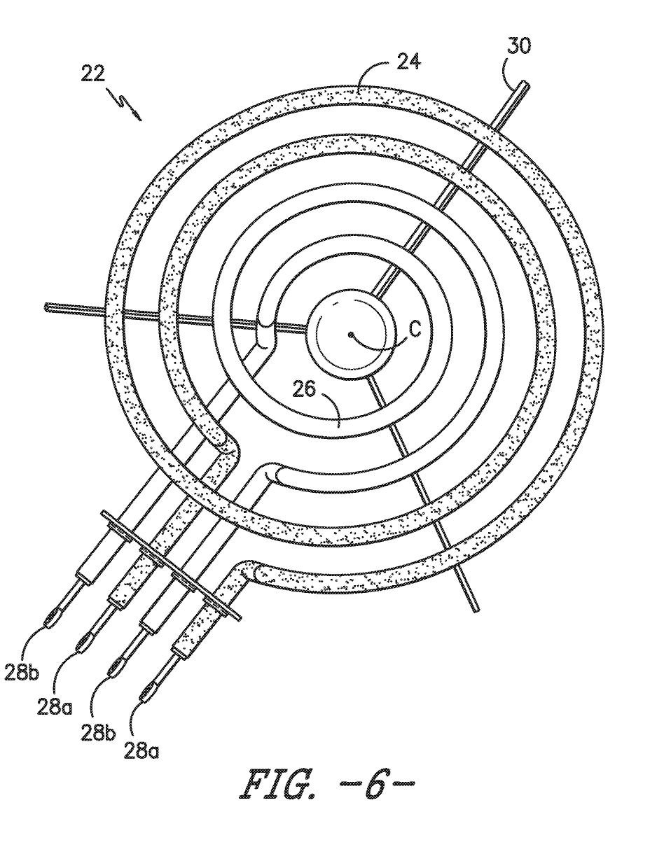

In the embodiment shown in FIG. 2, second portion 26 of heating assembly 22 preferably comprises a resistive temperature device (RTD) for sensing a temperature of a cooking utensil 12 positioned on heating assembly 22. However, in various embodiments, the temperature sensor of second portion 26 may be a RTD, a thermistor, a thermocouple (TC), or any other appropriate temperature sensing device. Like first portion 24, second portion 26 is exposed for sensing the temperature of cooking utensils placed directly on heating assembly 22, i.e., first portion 24 and second portion 26 contact a bottom surface 11 of cooking utensil 12 (FIG. 1) when cooking utensil 12 is positioned on heating assembly 22. As shown in FIG. 2, a length of second portion 26 may be configured in a generally circular or semi-circular shape, with a length of first portion 24 coiled around second portion 26. That is, second portion 26 may be wound in a generally circular or semi-circular shape about a center point C or centerline C_{L} (FIG. 5), and first portion 24 may coil around second portion 26, with center point C in the center of the coils of first portion 24, such that second portion 26 is positioned between center point C and first portion 24. Preferably, first portion 24 and second portion 26 are coplanar, as further described below.

Referring still to FIG. 2, heating assembly 22 has four terminals 28, two terminals 28a for first portion 24 and two terminals 28b for second portion 26. Terminals 28a provide power, i.e., a voltage V, from a power source (not shown) to the heat generating portion 24 of heating assembly 22. Additionally or alternatively, first portion 24 and/or second portion 26 may be in operative communication with a controller or other control mechanism via terminals 28. For example, through terminals 28b, second portion 26 may communicate to a control mechanism the sensed temperature of cooking utensil 12 positioned on heating assembly 22. The control mechanism may use the temperature readings provided by second portion 26 to control the power provided to first portion 24 and thereby control a heat output of first portion 24. As will be understood, by providing first portion 24 and second portion 26 with terminals 28, heating assembly 22 may be disconnected from the power source and from cooking appliance 10, e.g., to reposition the heating assembly, to remove the heating assembly for cleaning cooking surface 20, or the like. More particularly, co-locating terminals 28a, 28b as depicted in FIG. 2 may make it easier to disconnect and remove or reposition heating assembly 22.

Also as shown, heating assembly 22 may be supported on one or more support elements 30, which also help support cooking utensil 12 when the cooking utensil is placed on heating assembly 22. Further, although illustrated as forming a spiral shape by winding in coils approximately four times around a center point C, first portion 24 may have a different number of turns, other shapes, or other configurations as well. Additionally, although in the exemplary embodiment of FIG. 2 second portion 26 is configured in a generally circular shape, i.e., having a single turn, within the coils of first portion 24, i.e., within a space between center point C and the coils of first portion 24, second portion 26 also may have more turns, other shapes, or other configurations. Various other embodiments of first portion 24 and second portion 26 are described in greater detail below.

As mentioned, the operation of cooking appliance 10, including heating assemblies 22, may be controlled by a processing device such as a controller 32, which may include a microprocessor or other device that is in operative communication with components of appliance 10. Controller 32 may include a memory and microprocessor, such as a general or special purpose microprocessor operable to execute programming instructions or micro-control code associated with a selected heating level or cooking cycle. The memory may represent random access memory such as DRAM, and/or read only memory such as ROM or FLASH. In one embodiment, the processor executes programming instructions stored in memory. The memory may be a separate component from the processor or may be included onboard within the processor. Alternatively, controller 32 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Controls 18 and other components of cooking appliance 10 may be in communication with controller 32 via one or more signal lines or shared communication busses.

Using the measurements provided by second portion 26, controller 32 may control the heat output of first portion 24 to regulate the heat output of heating assembly 22 to a temperature or heat output selected by the user, or to limit the temperature of the cooking utensil regardless of the user-specified setting. For example, using the temperature measurements, controller 32 may cycle, i.e., pulse width modulate (PWM), the heating element(s) of first portion 24 between an activated state and a deactivated state, i.e., between on and off, such that the average heat output over each cycle approximates the selected heat output or heating level. That is, controller 32 may control the duty cycle of first portion 24 such that, based on the user's selected heat output or heating level, controller 32 activates or turns on first portion 24 for a fraction or portion of the duty cycle and deactivates or turns off first portion 24 for the remainder of the duty cycle.

In some embodiments, one or more components of cooking appliance 10 may be controlled independent of controller 32. For example, the heat output of first portion 24 of heating assembly 22 may be controlled by a mechanical or electromechanical control mechanism 34. In a particular example, control mechanism 34 is a bi-metal infinite switch that controls the duty cycle of first portion 24 of heating assembly 22, e.g., by opening or closing to regulate the amount of time the heating element(s) of first portion 24 is on or activated during the duty cycle. More specifically, a user of cooking appliance 10 may, e.g., manipulate a control 18 associated with a heating assembly 22 to select a desired heat output for the associated heating assembly 22. The selection by the user indicates to controller 30 what fraction or portion of the duty cycle first portion 24 should be activated or on, e.g., if the user selects the midpoint heat output or temperature, the infinite switch 34 may be closed for half the duty cycle such that first portion 24 is on for half of the duty cycle, and the infinite switch 34 may be open for the remainder of the duty cycle such that first portion 24 is off for half of the duty cycle.

In other embodiments, a combination of controller 32 and one or more other control mechanisms 34 may be used to control the features of cooking appliance 10. As an example, controller 32 may control the heat output of first portion 24 during one or more operating modes of appliance 10 and another control mechanism 34, such as an infinite switch, may control the heat output during other operating modes of appliance 10. Of course, controller 32 and/or control mechanism(s) 34 may have other constructions or configurations and may control the heat output and/or temperature sensing of heating assembly 22 in other ways as well.

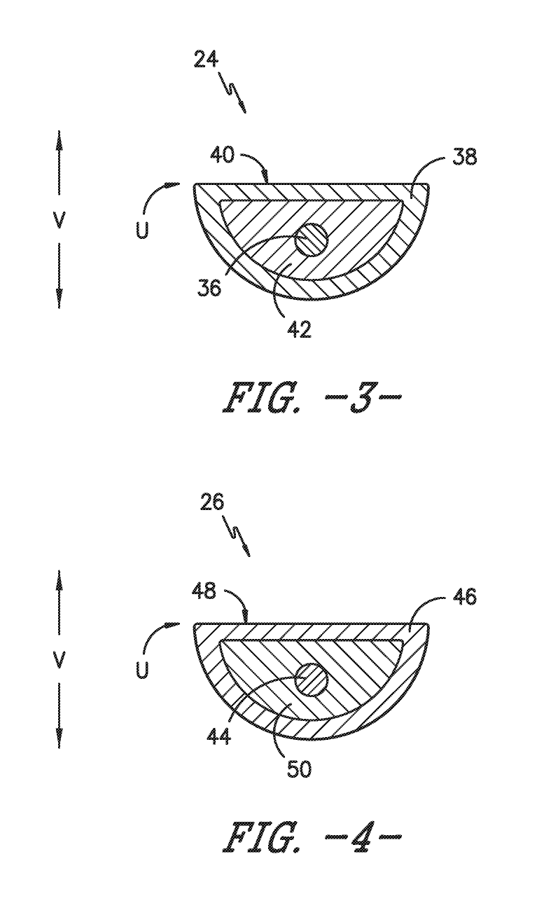

FIG. 3 provides a cross-section view of first portion 24 of heating assembly 22. As illustrated, first portion 24 includes a heating element or heat generating component 36 surrounded by a first sheath 38. For example, heat generating component 36 may be a heat generating wire, e.g., an electric resistance heating wire constructed from a material having a relatively low or small temperature coefficient of resistance (TCR) such that its resistance does not vary greatly with changes in temperature. In exemplary embodiments, the heat generating component 36 is a nichrome wire.

In the embodiment depicted in FIG. 3, first portion 24 has a generally semi-circular cross-section defined by first sheath 38, including a substantially flat first support surface 40 for supporting a cooking utensil 12 positioned on heating assembly 22. That is, first sheath 38 defines first support surface 40 at a vertically upper portion U of first portion 24 such that cooking utensil 12 may be supported thereon. Further, although shown in FIG. 3 with only one heat generating component 36, in other embodiments, first portion 24 of heating assembly 22 may include any appropriate number of heat generating components 36. For example, first portion 24 may comprise a plurality of heat generating wires 36 surrounded by first sheath 38. Additionally, first portion 24 may have other cross-sectional shapes or configurations.

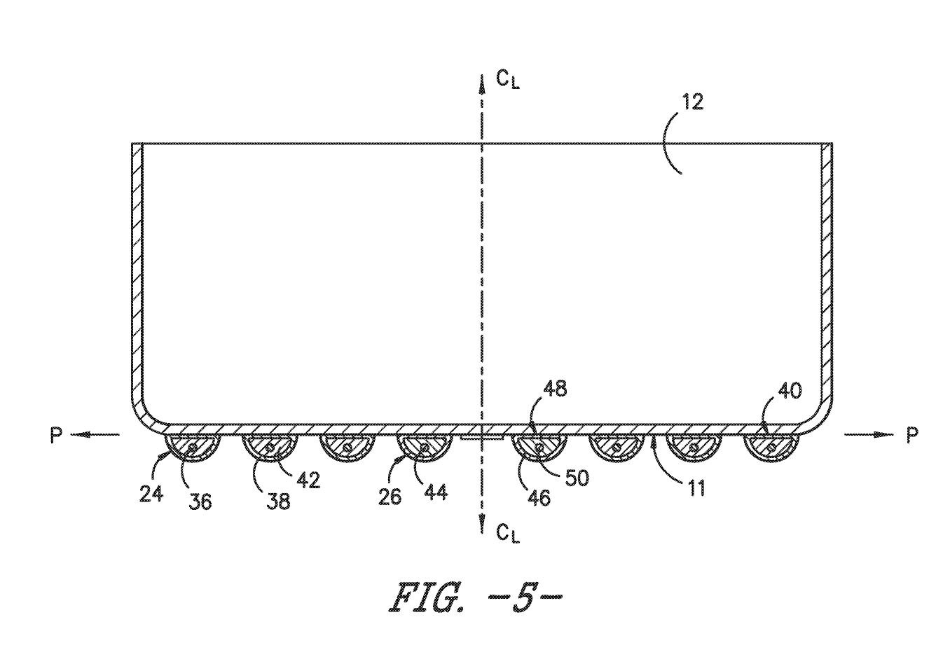

FIG. 4 provides a cross-section view of second portion 26 of heating assembly 22. As illustrated, second portion 26 includes a temperature sensing component 44 surrounded by a second sheath 46. For example, temperature sensing component 44 may be a temperature sensitive wire, e.g., a wire that functions as a RTD, having a small diameter and constructed from a material with a relatively high or large temperature coefficient of resistance (TCR) such that its resistance varies greatly with changes in temperature. Suitable materials for forming the temperature sensitive wire 44 in such embodiments include copper, aluminum, platinum, tungsten, iron, chromium, and/or nickel, as well as metal alloys, e.g., nickel and iron alloys such as NiFethal 52 or NiFethal 70, and/or nickel, iron, and chromium alloys such as Nikrotal 40. Further, temperature sensing component 44 may be formed in a linear spiral shape, e.g., similar to a spring or telephone cord, to maximize its resistance.

In the embodiment shown in FIG. 4, second portion 26 is substantially similar in cross-sectional shape to first portion 24. As such, second portion 26 has a generally semi-circular cross-section defined by second sheath 46, including a substantially flat second support surface 48 for supporting a cooking utensil 12 positioned on heating assembly 22. That is, second sheath 46 defines second support surface 48 at a vertically upper portion U of second portion 26 such that cooking utensil 12 may be supported thereon. More particularly, second support surface 48 is coplanar with first support surface 40 such that cooking utensil 12 may be supported by first and section portions 24, 26 of heating assembly 22. Thus, when utensil 12 is positioned on heating assembly 22, bottom surface 11 of utensil 12 contacts first support surface 40 and second support surface 48. It will be appreciated that, like first portion 24, second portion 26 may have other cross-sectional shapes or configurations. Further, the cross-sectional shape of second portion 26 need not be identical to the cross-sectional shape of first portion 24.

Further, in the exemplary embodiment of FIG. 3, heat generating component 36 is surrounded by an insulating material 42, and insulating material 42 is surrounded by first sheath 38. Similarly, in the exemplary embodiment of FIG. 4, temperature sensing component 44 is surrounded by an insulating material 50, and insulating material 50 is surrounded by second sheath 46. In one exemplary embodiment, the same insulating material 42, 50 may be used in first portion 24 and second portion 26, and the insulating material may be magnesium oxide. However, in other embodiments, first portion 24 may use a different insulating material than second portion 26, and other insulating materials than magnesium oxide may be used. Further, in some embodiments, first sheath 38 and second sheath 46 may be made from an alloy such as, e.g., Inconel®. In other embodiments, sheaths 38, 46 may be made from any other suitable material, and sheaths 38, 46 may be made from the same or different materials.

FIG. 5 provides a cross-sectional view of heating assembly 22 with a cooking utensil 12 positioned thereon. As shown, first support surface 40 and second support surface 48 lie within a plane P such that first and second support surfaces 40, 48 are co-planar. Accordingly, when cooking utensil 12 is positioned on heating assembly 22 as depicted in FIG. 5, bottom surface 11 of utensil 12 contacts first portion 24 and second portion 26 of heating assembly 22. In this way, heat from heat generating component 36 can be transferred to utensil 12, and temperature sensing component 44 can sense the temperature of utensil 12. Using temperature measurements from temperature sensing component 44, the heat output by heat generating component 36 can be regulated or modulated to control the temperature of cooking utensil 12 and any food items therein. By regulating or modulating the heat output of heat generating component 36, the temperature of utensil 12 and any food items therein can, e.g., be kept below a threshold temperature to avoid any potentially unsafe conditions of cooking appliance 10, such as smoke, fire, or the like.

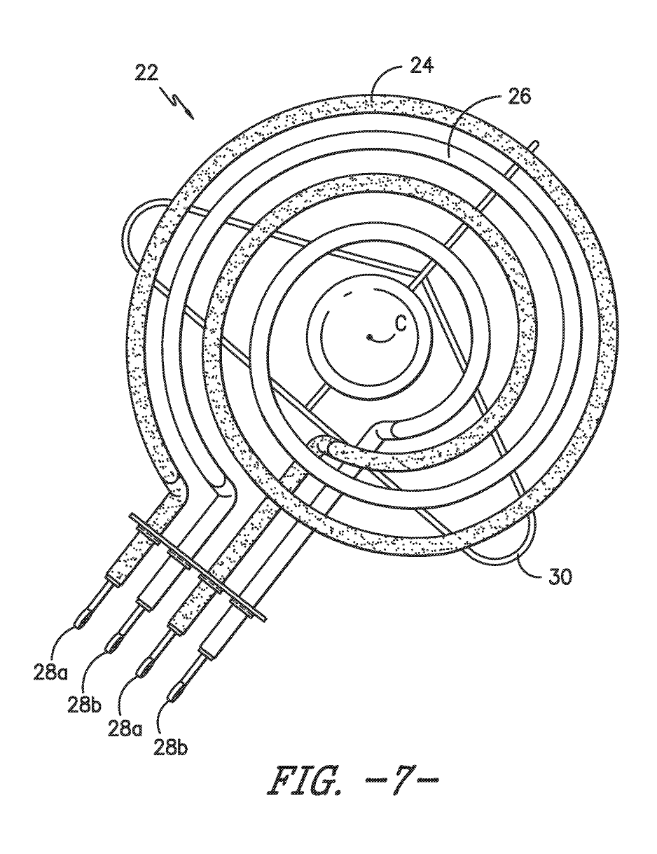

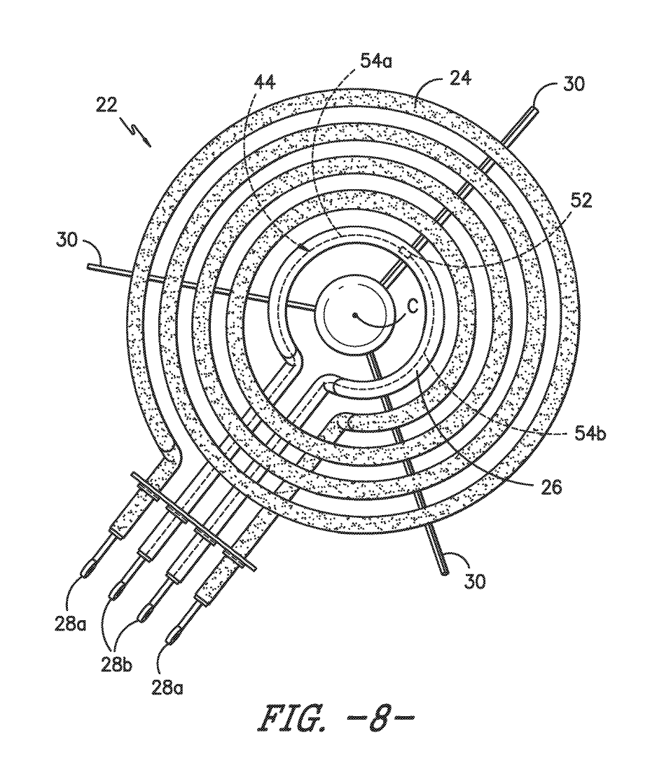

As further shown in FIG. 5, first portion 24 and second portion 26 are aligned about a centerline C_{L}. In some embodiments, such as shown in FIG. 2, second portion 26 is configured in a generally circular or semi-circular shape centered about centerline C_{L}, and first portion 24 is formed in a generally planar helical shape about second portion 26 such that first portion 24 is coiled and centered about centerline C_{L}. In other embodiments, such as shown in FIGS. 6 and 7 described in greater detail below, second portion 26 also may be formed in a generally planar helical shape such that second portion 26 is coiled about centerline C_{L}.

Turning now to FIG. 6, a top, perspective view is provided of heating assembly 22 according to another exemplary embodiment of the present subject matter. As shown in FIG. 6, in some embodiments second portion 26 may be coiled about center point C like first portion 24. More particularly, second portion 26 may be configured as a helical coil or spiral about center point C, and first portion 24 likewise may be configured as a helical coil or spiral about center point C, with second portion 26 positioned within a space between center point C and first portion 24. Stated differently, a length of second portion 26 may be coiled about center point C, and a length of first portion 24 may be coiled about second portion 26, with center point C central to the coils of first portion 24. In other words, second portion 26 is concentric with and surrounded by first portion 24. First portion 24 and second portion 26 otherwise may be formed as described with respect to FIGS. 2, 3, 4, and 5, and it will be understood that, as in FIG. 2, first portion 24 is shaded for purposes of clarity only and, at least externally, need not be visually different from second portion 26.

Referring to FIG. 7, a top, perspective view is provided of heating assembly 22 according to still another exemplary embodiment of the present subject matter. In the embodiment depicted in FIG. 7, similar to the embodiment of FIG. 6, a length of first portion 24 is coiled about center point C and a length of second portion 26 also is coiled about the center point C. Unlike the embodiment of FIG. 6, however, the coils of first portion 24 alternate with the coils of second portion 26 such that the coils of first and second portions 24, 26 are intertwined about the center point C. Stated differently, the coils of first portion 24 alternate with coils of second portion 26 such that a coil of second portion 26 is positioned between the coils of first portion 24 as the portions wind around center point C. In other words, second portion 26 and first portion 24 are co-wound in a spiral about common center point C. It will be appreciated that, as stated with respect to the embodiment of FIG. 6, first portion 24 and second portion 26 otherwise may be formed as described with respect to FIGS. 2, 3, 4, and 5, and it will be appreciated that, as in FIGS. 2 and 6, first portion 24 is shaded for purposes of clarity only and, at least externally, need not be visually different from second portion 26.

FIG. 8 provides a top, perspective view of heating assembly 22 according to yet another exemplary embodiment of the present subject matter. As with FIGS. 2, 6, and 7, it will be understood that first portion 24 is shaded for purposes of clarity only and, at least externally, need not be visually different from second portion 26. In the embodiment shown in FIG. 8, temperature sensing component 44 of second portion 26 of heating assembly 22 is a temperature sensor encased within second sheath 46, rather than a temperature sensitive wire encased within second sheath 46 as described above. For example, temperature sensing component 44 may be a temperature sensing device 52 with a pair of lead-out wires 54a, 54b bonded to the device; device 52 and lead-out wires 54a, 54b are all contained or encased within second sheath 46, as shown in FIG. 4 with component 44 contained within sheath 46. Temperature sensing device 52 may be a RTD, thermistor, thermocouple, or any appropriate temperature sensor. Each wire 54a, 54b is bonded to a terminal of the temperature sensing device 52 to form temperature sensing component 44. As shown in FIG. 8, temperature sensing device 52 may be positioned essentially in a center of the length of second portion 26 curved about center point C. In such embodiments, the measurement of temperature by temperature sensing component 44 is indicated by the change in resistance of embedded temperature sensing device 52, preferably with little to no contribution to the measurement from any heat generated resistance change of the lead-out wires 54a, 54b. Also, temperature sensing device 52 may be two or more identical devices connected in series about the path formed by second portion 26; that is to say, multiple temperature sensing devices 52 may be spaced essentially uniformly about second portion 26 so as to measure the average temperature of the cooking utensil at multiple locations, e.g., approximately near the center of the utensil. For example, three identical temperature sensing devices 52 could be positioned essentially over the three support arms of support structure 30 so as to optimize the temperature measurement accuracy by measuring the utensil temperature generally where maximal pressure is exerted between the utensil's bottom surface 11 and top surface 48 of second portion 26.

Further, in some embodiments, each wire of the pair of wires 54a, 54b is made of a different metal and bonded at a point to form a thermocouple (TC). The thermocouple is the temperature sensing component 44 of heating assembly 22 and, more particularly, a temperature sensor 44 as described above. In other words, the TC formed by the bonding of the two dissimilar metals replaces temperature sensing device 52 previously described. In one embodiment, one wire may be formed from iron and one wire from constantan to form a Type J thermocouple junction when bonded together. Such a thermocouple may have a thermoelectric sensitivity of approximately 50 μV/° C. Further, each wire 54a, 54b has an end exiting second sheath 46. In such embodiments, the measurement of temperature is indicated by the voltage generated between the two wire ends exiting second sheath 46. Preferably, any heating of lead-out wires 54a, 54b makes little to no contribution to the temperature of cooking utensil 12 sensed by temperature sensing component 44. In other embodiments, the lead-out wires 54a, 54b may be made from other dissimilar metals to form other types of thermocouples, e.g., the lead-out wires may be fabricated from Chromel and Alumel to form a Type K thermocouple or from Nicrosil and Nisil to form a Type N thermocouple.

As another example, in some embodiments the pair of lead-out wires 54a, 54b may comprise one wire 54a having its end bonded to second sheath 46 within second sheath 46, i.e., within the area enclosed by second sheath 46 and in which temperature sensing component 44 is positioned. More particularly, the wire 54a is bonded to second sheath 46 approximately in the center of its length that curves about center point C. In such embodiments, the lead-out wire 54a may be formed from one metal and second sheath 46 may be formed from a second metal such that second sheath 46 functions as the second lead-out wire 54b, with a thermocouple (TC) formed at the junction between the dissimilar metals, i.e., at the point where the wire 54a is bonded to second sheath 46. The thermocouple is temperature sensing component 44 and, more specifically, a temperature sensor 44 that may be used in place of temperature sensing device 52 described above. In one embodiment, the wire 54a may be formed from copper and second sheath 46 formed from steel. Such a thermocouple may have a thermoelectric sensitivity of approximately 3 μV/° C. Like the previous example, the measurement of temperature is indicated by the voltage generated between the two wires, i.e., wire 54a and sheath 46, preferably with little to no contribution by the heat of the wires to the temperature of cooking utensil 12 sensed by temperature sensing component 44.

It will be understood that, although temperature sensing component 44 may be configured differently in embodiments such as those described with respect to FIG. 8, first portion 24 and second portion 26 otherwise may be formed as described with respect to FIGS. 2, 3, 4, and 5. For example, for embodiments of heating assembly 22 such as those described with respect to FIG. 8, as well as those described with respect to FIGS. 6 and 7, first portion 24 and second portion 26 are integrated such that the heating assembly 22 is removable from cooking appliance 10 as a single unit. Moreover, first portion 24 includes heat generating component 36 encased within first sheath 38, which defines first support surface 40. Second portion 26 includes temperature sensing device 44 encased within second sheath 46, which defines second support surface 48. First support surface 40 and second support surface 48 are co-planar such that a cooking utensil 12 positioned on heating assembly 22 may be supported by first portion 24 and second portion 26, i.e., bottom surface 11 of utensil 12 is in contact with first and second portions 24, 26 when utensil 12 is positioned on heating assembly 22. Further, first portion 24 may include an insulating material 42 between heat generating component 36 and first sheath 38, and second portion 26 may include an insulating material 50 between temperature sensing component 44 and second sheath 46. Of course, various embodiments of heating assembly 22 also may have other similarities and differences.

As described herein, heating assembly 22 includes a temperature sensing component 44 integrated within the assembly 22. As such, the temperature sensing component 44 may be moved and/or repositioned as the heating element 36 of assembly 22 is moved and/or repositioned. Also, temperature sensing component 44 may be removed with heating assembly 22, e.g., to enable a user to clean cooking surface 20 of cooking appliance 10. Of course, integrating a temperature sensing component with a heat generating component within a single heating assembly may have other advantages as well that will be appreciated by those of ordinary skill in the art.

Although FIGS. 2, 6, 7, and 8 illustrate that first portion 24, that is, the heating-generating portion of the heating assembly 22, as a single planar helical spiral, other configurations are possible as well. For instance, in FIGS. 2, 6, and 8 the heating portion of the assembly 24 may be broken-up into 2 or more heating portions such that the heating assembly 22 may efficiently accommodate different cooking utensil diameters. For instance, heating portion 24 may contain 2 heating portions, the first of which with an outer diameter of e.g. 7″ and the second of which with an outer diameter of e.g. 10″. The user of the appliance could then indicate, via control panel 16, whether a “large” utensil or a “small” utensil was to be heated. Of course, this would then force electrical connector 28 to have 3 pairs of terminals; two pairs for heating and one pair for temperature sensing. Similarly, one skilled in the art could imagine a variant of FIG. 7 in which the two co-wound sheaths were replaced with 3 co-wound sheaths; two sheaths for heating, one sheath for temperature sensing. This would offer the advantage that at low power levels e.g. simmer or melting chocolate only one of the heating portions would be activated while at high power levels e.g. boiling pasta both of the heating portions would be activated. As in the previous example, electrical connector 28 becomes 3 pairs of connections.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A heating assembly for a cooktop appliance, the heating assembly comprising:
a first portion including
a heat generating component, and
a first sheath surrounding the heat generating component, the first sheath defining a first support surface; and
a second portion including
a temperature sensing component, and
a second sheath surrounding the temperature sensing component, the second sheath defining a second support surface,
wherein the first support surface and the second support surface contact a cooking utensil when the cooking utensil is positioned on the heating assembly.

2. The heating assembly of claim 1, wherein a length of the second portion is configured in a generally circular shape, and wherein a length of the first portion is coiled about the circular shape of the second portion.

3. The heating assembly of claim 1, wherein a length of the first portion is coiled about a center point and a length of the second portion is coiled about the center point, and where coils of the first portion alternate with coils of the second portion such that the coils of the first and second portions are intertwined about the center point.

4. The heating assembly of claim 1, wherein the heat generating component is a heat generating wire.

5. The heating assembly of claim 1, wherein the temperature sensing component is a temperature sensitive wire.

6. The heating assembly of claim 1, wherein the temperature sensing component is a discrete temperature sensor, the temperature sensor encased within the second sheath.

7. The heating assembly of claim 1, wherein the first portion and second portion are integrated such that the heating assembly is removable from the cooking appliance as a single unit.

8. A heating assembly for a cooktop appliance, the heating assembly comprising:
a first portion including
a heat generating wire, and
a first sheath defining a first support surface, the heat generating wire extending within the first sheath such that the first sheath surrounds the heat generating wire; and
a second portion including
a temperature sensitive wire, and
a second sheath defining a second support surface, the temperature sensitive wire extending within the second sheath such that the second sheath surrounds the temperature sensitive wire,
wherein the first support surface and the second support surface contact a cooking utensil when the cooking utensil is positioned on the heating assembly.

9. The heating assembly of claim 8, wherein a length of the second portion is configured in a generally circular shape, and wherein a length of the first portion is coiled about the circular shape of the second portion.

10. The heating assembly of claim 8, wherein a length of the first portion is coiled about a center point and a length of the second portion is coiled about the center point, and where coils of the first portion alternate with coils of the second portion such that the coils of the first and second portions are intertwined about the center point.

11. The heating assembly of claim 8, wherein the heat generating wire has a low temperature coefficient of resistance.

12. The heating assembly of claim 8, wherein the heat generating wire is a nichrome wire.

13. The heating assembly of claim 8, wherein the temperature sensitive wire has a high temperature coefficient of resistance.

14. The heating assembly of claim 8, wherein the temperature sensitive wire is a platinum wire.

15. A heating assembly for a cooktop appliance, the heating assembly comprising:
a first portion including
a heat generating wire, and
a first sheath defining a first support surface, the heat generating wire extending within the first sheath such that the first sheath surrounds the heat generating wire; and
a second portion including
a temperature sensor, and
a second sheath surrounding the temperature sensor, the second sheath defining a second support surface,
wherein the first support surface and the second support surface contact a cooking utensil when the cooking utensil is positioned on the heating assembly.

16. The heating assembly of claim 15, wherein the second support surface is essentially coplanar with the first support surface.

17. The heating assembly of claim 15, wherein a length of the second portion is configured in a generally circular shape, and wherein a length of the first portion is coiled about the circular shape of the second portion.

18. The heating assembly of claim 15, wherein the temperature sensor comprises a temperature sensitive device with a pair of lead-out wires bonded thereto.

19. The heating assembly of claim 15, wherein the temperature sensor comprises a thermocouple formed from a junction of lead-out wires composed of two dissimilar metals.

20. The heating assembly of claim 15, wherein the temperature sensor comprises a thermocouple formed from a junction of a lead-out wire and the second sheath, the lead-out wire and second sheath being two dissimilar metals.
